(19) United States
(12) Patent Application Publication
(10) Pub. No.: US 2013/0273302 A1
(43) Pub. Date: Oct. 17, 2013

(54) Magnetic Door Latch Blocker

(71) Applicant: Christopher Ambrosi, Denville, NJ (US)

(72) Inventor: Christopher Ambrosi, Denville, NJ (US)

(21) Appl. No.: 13/445,028

(22) Filed: Apr. 12, 2012

(51) Int. Cl. B32B 3/06

(52) U.S. Cl. 428/99

(57) ABSTRACT

A magnetic latch blocker comprises an oblong flexible strip, one side of which is magnetized so that the strip will magnetically adhere to a metallic door jamb and cover the strike plate of a door. The magnetic strip has a sufficient width to cover the strike plate but not protrude much beyond the door jamb when the door is closed. In practice, the magnetic latch blocker strip would ordinarily remain fastened over the strike plate of the door, which would be left in the locked configuration. When the room was in use, the door would be closed with the locking latch blocked by the magnetic strip. Upon a “lock down” order being issued, someone within the room would partially open the door and pull out the magnetic strip, thereby releasing the latch and locking the door by pulling it fully closed.

### BACKGROUND OF THE INVENTION

The present invention relates to the field of devices which prevent a door from locking when it is closed. More particularly, the present invention relates to devices which block the door latch from engaging the opening in the door's strike plate, thereby keeping it in the unlocked configuration.

In recent years, heightened security concerns in government, academic and institutional buildings have given rise to “lock down” procedures, which call for rapid response locking of internal doorways in order to isolate a potential terrorist or gunman. In a high school setting, for example, a “lock down” exercise may involve simultaneous locking of all classroom doors to block access by a potential assailant to potential victims.

These “lock down” procedures have created the need for a means of quickly locking doors from the inside without the use of a key. Many public buildings use automatic locking doors, wherein the door is locked or unlocked by a key from the outside, and when locked the locking mechanism automatically engages when the door is closed. Consequently, if a classroom door is left unlocked while a class is in session, as it typically would be, a “lock down” would require someone to go outside the room with a key to lock the door and then reenter the classroom to pull the locked door closed. Aside from the obvious danger to the individual exiting the room to lock the door, the extra time required to effect this operation, during which the door remains open, poses an unacceptable risk to the occupants of the classroom.

The prior art relating to door latch blockers does not lend itself to the rapid removal of latch blockers which is essential to an effective “lock down” procedure. The prior includes three patents, each of which uses a mechanical means for preventing the latch from engaging the strike plate. The U.S. patent of Radcliff for a “Door Latch Holder” (U.S. Pat. No. 5,004,279) describes a strip of flexible material with looped ends designed to slip over the door knobs and thereby restrain the latch from extending outward. The U.S. patent of Mossotti et al. for a “Door Anti-Locking Device” (U.S. Pat. No. 6,082,790) discloses a rigid plate rotatably attached to the top of the strike plate, so that when it is rotated downward, the plate covers the opening of the strike plate and thus blocks the latch from engaging. The U.S. patent of Wacker for a “Latch Guard” (U.S. Pat. No. 6,698,807) teaches the use of a rectangular piece insertable into the strike plate opening, so as to obstruct latch engagement.

In each of the foregoing devices, the removal of the latch blocker so as to lock the door requires that the door to first be fully opened, which is contrary to the security imperatives of an effective “lock down” procedure. A latch blocker suitable for rapid “lock down” must be one that remains in place even when the door is opened, yet can be quickly removed without completely opening the door.

The present invention addresses this need by providing an oblong flexible strip, one side of which is magnetized so that the strip will magnetically adhere to a metallic door frame. The magnetic strip has a sufficient width so that it covers the door's strike plate, thereby blocking the latch from engaging when the door is closed. During a “lock down,” the strip can be readily and quickly removed by partially opening the door, far enough to expose the strip, and then pulling the strip out from between the strike plate and the door. In practice, therefore, the magnetic latch blocker strip would under ordinary conditions remain magnetically fastened to the metallic door jamb and covering the strike plate of the door, which would be left in the locked configuration. When the room was in use, the door would be closed with the locking latch blocked by the magnetic strip. Upon a “lock down” order being issued, someone within the room would partially open the door, pull out the magnetic strip and re-close the door, thereby releasing the latch and locking the door without fully opening it.

While the patent literature discloses various uses for flexible magnetic sheets, none of these are functionally or structurally similar to the present invention. While the U.S. patent application of Molina for a “Car Door Dent Protector Device” (US 2003/0062732) teaches the insertion of a magnetic sheet between the door and door frame of an automobile, this is for the purpose of securing the device against theft, and bears no relation to the operation of the vehicle's door locking mechanism. Other applications of magnetic sheets to doors, as described in the U.S. patent of Toussant et al. (U.S. Pat. No. 6,929,173) and the U.S. patent application of Buckel (US 2009/0110948) serve purely decorative functions. Consequently, the patent literature discloses no obvious basis for using flexible magnetic sheets in connection with door latch blockers.

### SUMMARY OF THE INVENTION

The magnetic door latch blocker of the present invention comprises an oblong flexible strip, the reverse side of which is magnetized, and the obverse side of which has a non-magnetic durable surface that can be imprinted with words and/or graphic content. The magnetic latch blocker is about 6″ to 8″ in length and is approximately 1½″ 2″ in width—wider than a strike plate, and about as wide as a door jamb, so as not to leave a substantial inner protruding edge when the door is closed. It is placed over the strike plate on the metallic door frame, to which its magnetic reverse side becomes removably attached, thereby preventing the door latch from engaging the strike plate and locking the door. The latch blocker is particularly useful in public buildings, such as schools and government offices, where security requires rapid response “lock-down” procedures. In these applications, the doors can be left in locked mode with the latch blocker in place, and then the latch blocker can quickly be removed from the door without completely opening it to effectuate the “lock-down” rapidly and securely.

The foregoing summarizes the general design features of the present invention. In the following sections, a specific embodiment of the present invention will be described in some detail. This specific embodiment is intended to demonstrate the feasibility of implementing the present invention in accordance with the general design features discussed above. Therefore, the detailed description of this embodiment is offered for illustrative and exemplary purposes only, and it is not intended to limit the scope either of the foregoing summary description or of the claims which follow.

### BRIEF DESCRIPTION OF THE DRAWINGS

FIG. 1A depicts the obverse side of an exemplary magnetic latch blocker strip in accordance with the preferred embodiment of the present invention;

FIG. 1B depicts the reverse side of an exemplary magnetic latch blocker strip in accordance with the preferred embodiment of the present invention; and

FIG. 2 depicts a perspective view of an exemplary magnetic latch blocker strip in the foreground and a door jamb and strike plate in the background in accordance with the preferred embodiment of the present invention.

### DETAILED DESCRIPTION OF THE PREFERRED EMBODIMENT

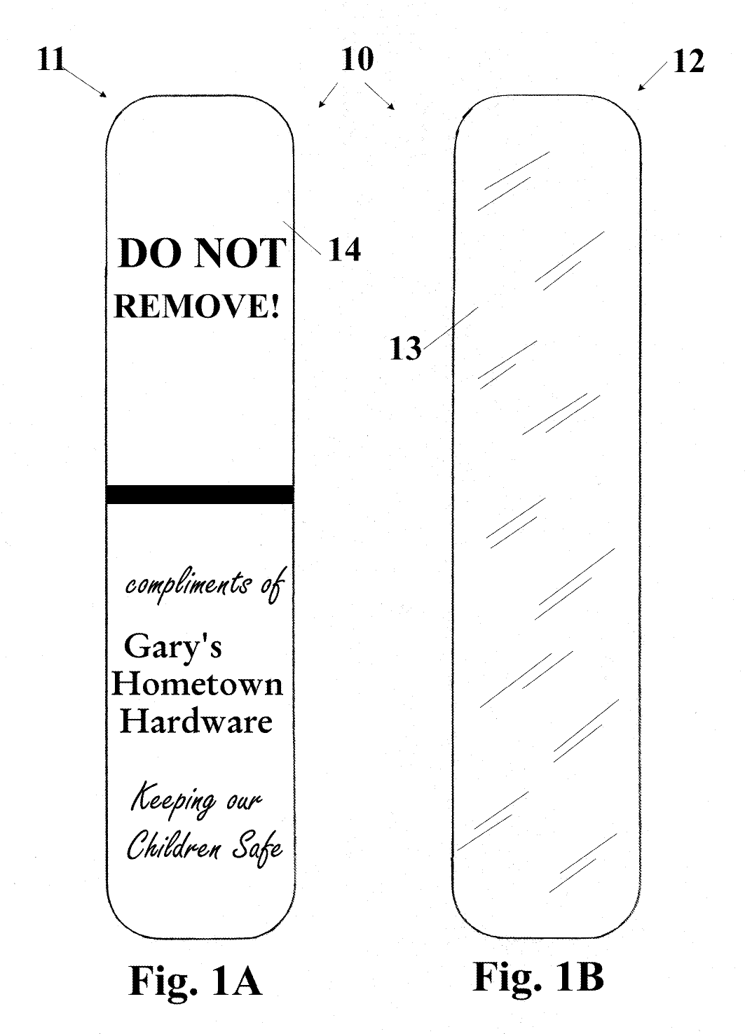

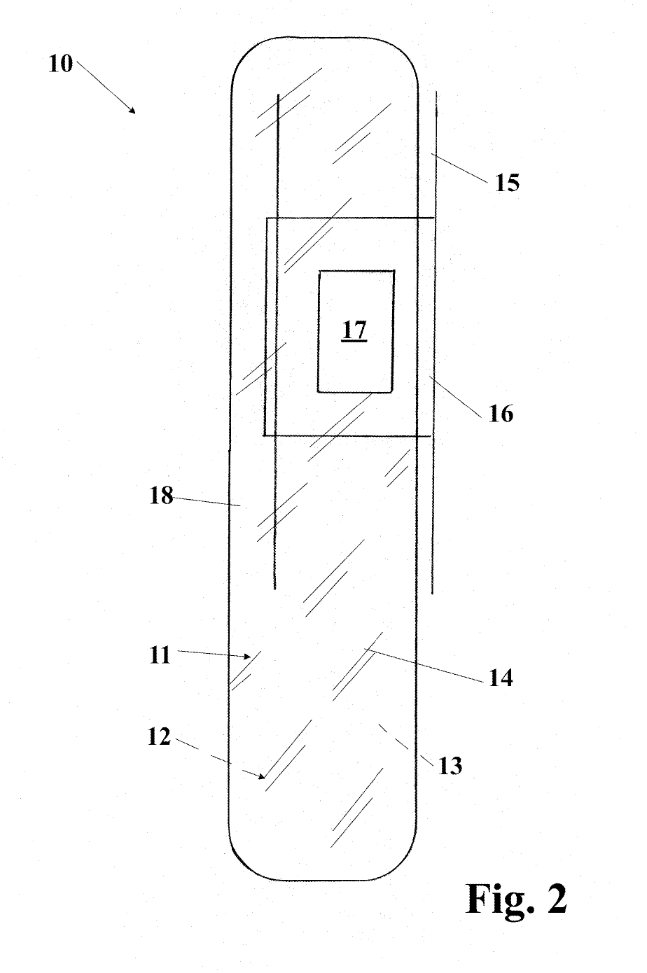

Referring to FIGS. 1A and 1B, the preferred embodiment of the magnetic latch blocker comprises an flexible oblong strip 10 having an obverse side 11 and a reverse side 12. The oblong strip 10 is preferably 6″ to 8″ long and 1½″ to 2″ wide, or of sufficient width so that the strip 10 covers the strike plate 17, but does not protrude 18 much beyond the door jamb 15 as shown in FIG. 2.

The obverse side 11 is covered with a durable layer 14 capable of being imprinted with graphic designs and alphanumeric indicia, as depicted in FIG. 1A. This provides the opportunity to use the obverse side 11 of the strip 10 to display safety and promotional messages. The reverse side 12 is covered with a magnetic layer 13 that magnetically adheres to metallic door jamb 15 and covers the strike plate 16, thereby preventing the door latch from engaging the aperture 17 of the strike plate to lock the door.

When the door is closed and the strip 10 is attached to the door jamb 15 over the strike plate 16, the door may be opened without unlocking it. When the situation calls for rapidly locking the door from the inside without fully opening it, the door is partially opened, the strip 10 is grasped and removed from the door jamb 15, and the door is pulled closed. Once this is done, the door latch is no longer restrained from engaging the aperture 17 of the strike plate 16, and the door locks itself.

Although the preferred embodiment of the present invention has been disclosed for illustrative purposes, those skilled in the art will appreciate that many additions, modifications and substitutions are possible, without departing from the scope and spirit of the present invention as defined by the accompanying claims.

What is claimed is:

1. A magnetic latch blocker comprising:
a flexible oblong strip having a obverse side and a reverse side;
wherein the obverse side is covered with a durable layer that can be imprinted with graphic and alphanumeric indicia;
wherein the reverse side is covered with a magnetic layer that is magnetically attachable to a metallic door jamb, so as to cover a strike plate of a door, and so as to block a door latch from engaging an aperture in the strike plate, thereby preventing the door from locking; and
wherein, when the door is closed with the latch blocker magnetically attached to the door jamb and covering the strike plate, the door can be partially opened to expose the oblong strip, which can then be removed from the door jamb, so that the door latch is no longer blocked from engaging the aperture in the strike plate, and the door becomes locked when it is again fully closed.

2. The magnetic latch blocker according to claim 1, wherein the durable layer of the obverse side of the oblong strip is imprinted with safety and/or promotional messages.
